(19) United States
(12) Patent Application Publication
(10) Pub. No.: US 2024/0191485 A1
(43) Pub. Date: Jun. 13, 2024

(54) Solid Cleaning Agent Containment Device And Method Of Use

(71) Applicant: Jesus Llamas, Redlands, CA (US)

(72) Inventor: Jesus Llamas, Redlands, CA (US)

(21) Appl. No.: 18/079,369

(22) Filed: Dec. 12, 2022

(51) Int. Cl. E03D 9/03; C11D 3/395; C11D 11/00; C11D 17/00; C11D 17/04

(52) U.S. Cl. CPC E03D 9/038; C11D 3/3953; C11D 11/0023; C11D 17/0056; C11D 17/046; E03D 2009/024

(57) ABSTRACT

A solid cleaning agent containment device for toilet cleaning agents includes a tube, which in turn comprise a first segment and a second segment. The first segment has a closed end and an open end, while the second segment has a closed terminus and an open terminus. The second segment is circumferentially smaller than, and adjustably positionable within, the first segment so that the tube is selectively length adjustable to fit substantially between a front wall and a rear wall of a tank of a toilet. The tube can contain a solid cleaning agent and can be positioned in a tank of a toilet. A plurality of holes that is positioned in the tube allows entry of water into the tube and exiting of a solution resulting from dissolving of the solid cleaning agent in the water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to containment devices and more particularly pertains to a new containment device for toilet cleaning agents. The present invention discloses a containment device comprising a length adjustable tube for holding chlorine tablets, which can be added to the tube and which dissolve into water that enters the tube via a plurality of holes.

### (2) Description of Related Art Including Information Disclosed Under 37 CFR 1.97 and 1.98

The prior art relates to containment devices, which may comprise filter cups that can be clipped to overflow tubes within toilet tanks, devices that position chlorine tablets in line with toilet tank refill lines, devices that hang from rims of toilet tanks, and clamshell containers with holes for containing chlorine tablets. What is lacking in the prior art is a containment device comprising a length adjustable tube that can be adjusted to fit between a front wall and a back wall of a toilet tank. Chlorine tablets can be added to the tube and dissolve into water that enters the tube via a plurality of holes.

### BRIEF SUMMARY OF THE INVENTION

An embodiment of the disclosure meets the needs presented above by generally comprising a tube, which in turn comprise a first segment and a second segment. The first segment has a closed end and an open end, while the second segment has a closed terminus and an open terminus. The second segment is circumferentially smaller than, and adjustably positionable within, the first segment so that the tube is selectively length adjustable to fit substantially between a front wall and a rear wall of a tank of a toilet. The tube is configured to contain a solid cleaning agent and to be positioned in a tank of a toilet. A plurality of holes is positioned in the tube and are configured to allow entry of water into the tube and to allow exiting of a solution resulting from dissolving of the solid cleaning agent in the water.

Another embodiment of the disclosure includes a solid cleaning agent containment system, which comprises the solid cleaning agent containment device, as disclosed above, having a solid cleaning agent positioned in a tube of the solid cleaning agent containment device.

Yet another embodiment of the disclosure includes a method of maintaining a clean and sanitary toilet. The method entails provision of a toilet, a solid cleaning agent, and a solid cleaning agent containment device, according to the disclosure above. First and second operational steps are adding the solid cleaning agent to the tube and positioning the tube in a tank of a toilet between a front wall and a back wall of the tank, respectively. First and second usage steps of the method are allowing the solid cleaning agent to dissolve, and, as needed, flushing the toilet, respectively.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a solid cleaning agent containment device according to an embodiment of the disclosure.

FIG. 2 is an isometric perspective view of an embodiment of the disclosure.

FIG. 3 is an end view of an embodiment of the disclosure.

FIG. 4 is a side view of an embodiment of the disclosure.

FIG. 5 is a cross-sectional view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

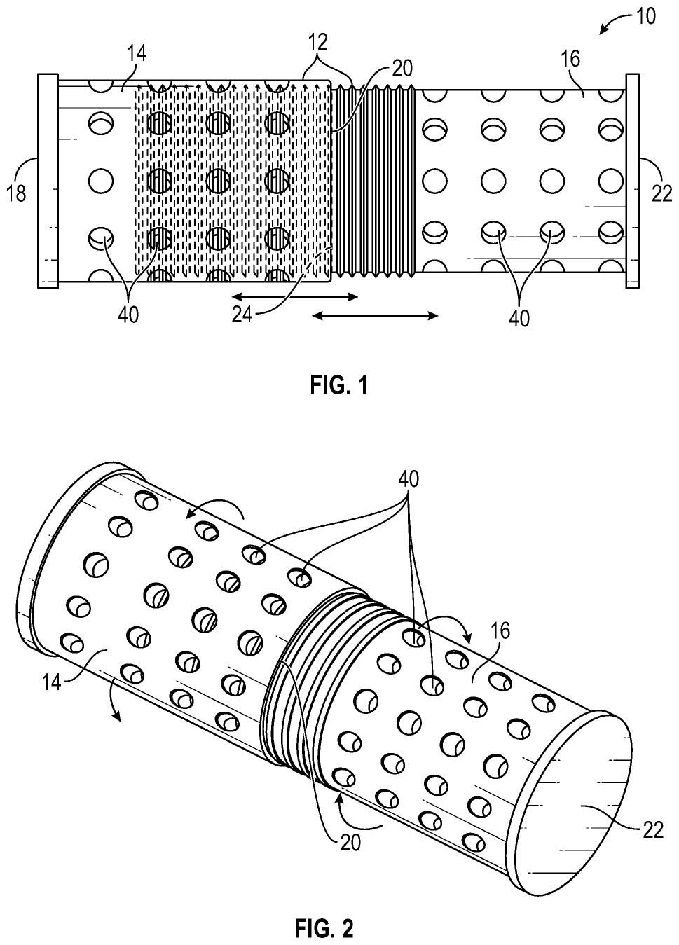

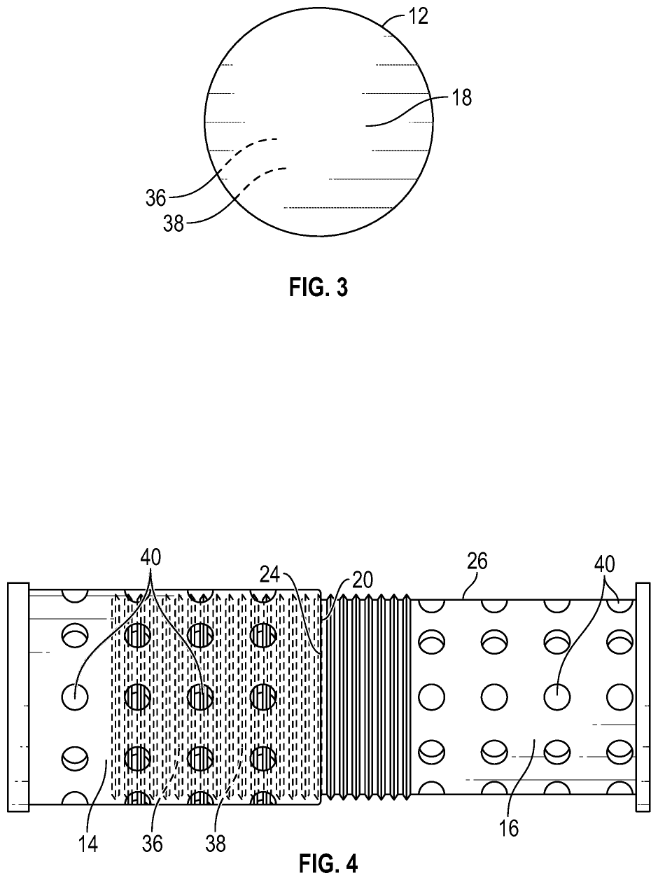

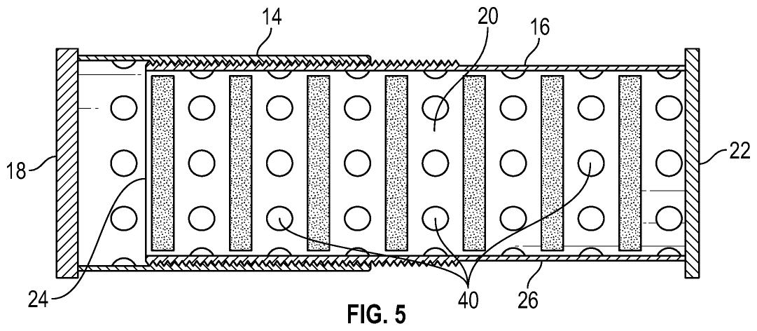

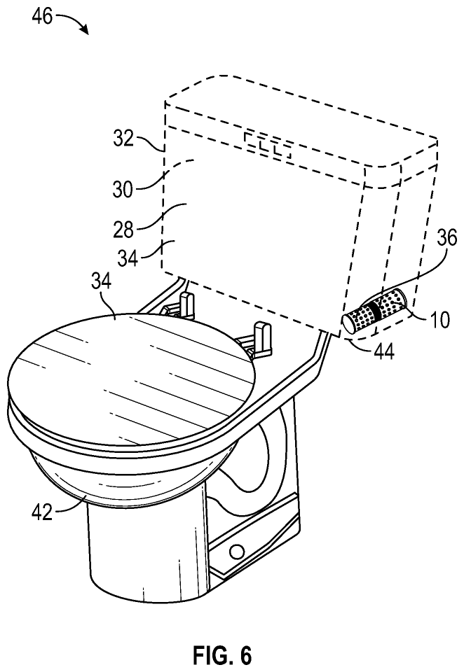

With reference now to the drawings, and in particular to FIGS. 1 through 7 thereof, a new containment device embodying the principles and concepts of an embodiment of the disclosure and generally designated by the reference numeral 10 will be described.

As best illustrated in FIGS. 1 through 7, the solid cleaning agent containment device 10 generally comprises a tube 12, which in turn comprise a first segment 14 and a second segment 16. The first segment 14 has a closed end 18 and an open end 20, while the second segment 16 has a closed terminus 22 and an open terminus 24. The second segment 16 is circumferentially smaller than, and adjustably positionable within, the first segment 14 so that the tube 12 is selectively length 26 adjustable to fit substantially between a front wall 28 and a rear wall 30 of a tank 32 of a toilet 34.

In one configuration of the solid cleaning agent containment device 10, the first segment 14 of the tube 12 is internally threaded adjacent to the open end 20. The second segment 16 of the tube 12 is circumferentially smaller than the first segment 14 and is externally threaded adjacent to the open terminus 24. The second segment 16 thus is selectively threadedly attachable to the first segment 14 and the tube 12 is length 26 adjustable by selective counterrotation of the second segment 16 and the first segment 14.

The present invention anticipates other means for rendering the tube 12 selectively length 26 adjustable. For example, the second segment 16 could be slidable relative to the first segment 14 and fixable to the first segment 14 by a variety of means, such as, but not limited to, twist locks, cam locks, and the like. A length 26 of the tube 12 is adjustable between 10.0 to 25.0 cm. In one configuration, the length 26 of the tube 12 is adjustable between 12.7 to 20.3 cm.

The tube 12 is configured to contain a solid cleaning agent 36 and to be positioned in a tank 32 of a toilet 34. Such solid cleaning agents 36 are of common use in maintaining cleanliness and sanitation of toilets 34 and typically comprise chlorine tablets 38, with or without other agents or dyes. A plurality of holes 40 is positioned in the tube 12 and is configured to allow entry of water into the tube 12 and to allow exiting of a solution that results from dissolving of the solid cleaning agent 36 in the water. As a user flushes the toilet 34, the solution flows to a bowl 42 of the toilet 34, thereby cleaning and sanitizing the bowl 42.

The holes 40 may be sized to contain pieces of chlorine tablets 38 so they do not interfere with flushing of the toilet 34. It also is anticipated that one or both of the first segment 14 and the second segment 16 may be partially meshed, thus providing a plurality of holes 40 that are quite small. While the holes 40 shown in FIGS. 1 and 2 are circular, the present invention anticipate the holes 40 being alternatively shaped, such as, but not limited to, rectangular, triagonal, ovoid, elongated slot shaped, and the like.

The quantity of holes 40 in the plurality of holes 40 can be varied to control a rate at which the solid cleaning agent 36 is dissolved. For example, a solid cleaning agent containment device 10 intended for home use might have smaller holes 40, leading to a slower rate of dissolving of the solid cleaning agent 36, which would be appropriate for a toilet 34 having low usage. A toilet 34 intended for public use, with high usage, might be better served with a solid cleaning agent containment device 10 wherein the holes 40 are larger.

The tube 12 could be positioned in the tank 32 where the front wall 28 and the rear wall 30 have their maximum separation, thereby limiting lateral movement of the tube 12. Rather than letting the tube 12 sink to a bottom 44 of the tank 32, a user could extend the tube 12 so that the tube 12 frictionally engages the front wall 28 and the rear wall 30 of the tank 32, thereby allowing selective positioning of the tube 12 above the bottom 44.

The present invention anticipates a solid cleaning agent containment system 46, which comprises a solid cleaning agent containment device 10, as described in the specification above, having a solid cleaning agent 36 positioned in a tube 12 of the solid cleaning agent containment device 10. The solid cleaning agent containment system 46 also may comprise a toilet 34, with the tube 12 being positioned between a front wall 28 and a back wall of a tank 32 of the toilet 34. The present invention also anticipates the solid cleaning agent 36 of the solid cleaning agent containment system 46 comprising a chlorine tablet 38.

The solid cleaning agent containment device 10 enables a method of maintaining a clean and sanitary toilet 48. The method 48 comprises a first provision step 50, which entails providing a toilet 34 and a solid cleaning agent 36. A second provision step 52 of the method 48 is providing a solid cleaning agent containment device 10, according to the specification above. A first operational step 54 of the method 48 is adding the solid cleaning agent 36 to the tube 12. The solid cleaning agent 36 of the method 48 may comprise at least one chlorine tablet 38. A second operational step 56 of the method 48 is positioning the tube 12 in a tank 32 of a toilet 34 between a front wall 28 and a back wall of the tank 32. A first usage step 58 of the method 48 is allowing the solid cleaning agent 36 to dissolve to form a solution. A second usage step 60 of the method 48 is flushing the toilet 34, when needed, so that the solution flows from the tank 32 to a bowl 42 of the toilet 34 to clean and to sanitize the bowl 42.

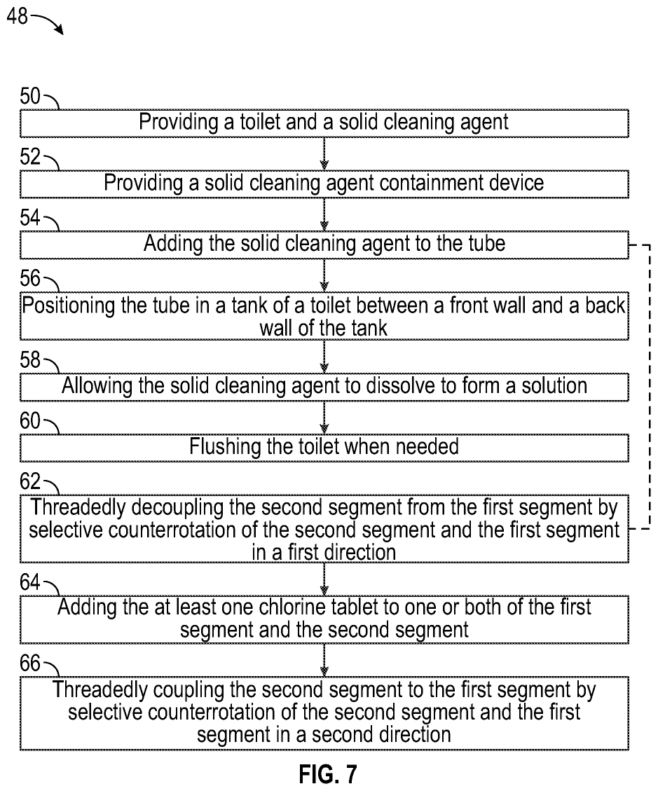

In a configuration, wherein the second segment 16 is selectively threadedly attachable to the first segment 14 and the solid cleaning agent 36 comprises at least one chlorine tablet 38, the first operational step 54 entails the following steps, as shown in FIG. 7. An opening step 62, which is threadedly decoupling the second segment 16 from the first segment 14 by selective counterrotation of the second segment 16 and the first segment 14 in a first direction, an addition step 64, which is adding the at least one chlorine tablet 38 to one or both of the first segment 14 and the second segment 16, and a closing step 66, which is threadedly coupling the second segment 16 to the first segment 14 by selective counterrotation of the second segment 16 and the first segment 14 in a second direction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A solid cleaning agent containment device comprising:
a tube comprising:
a first segment having a closed end and an open end, and
a second segment having a closed terminus and an open terminus, the second segment being circumferentially smaller than and adjustably positionable within the first segment, such that the tube is selectively length adjustable to fit substantially between a front wall and a rear wall of a tank of a toilet, wherein the tube is configured for containing a solid cleaning agent and for positioning in a tank of a toilet; and
a plurality of holes positioned in the tube, wherein the holes are configured for entry of water into the tube and for exiting of a solution resulting from dissolving of the solid cleaning agent in the water.

2. The solid cleaning agent containment device of claim 1, wherein:
the first segment of the tube is internally threaded adjacent to the open end; and
the second segment of the tube is circumferentially smaller than the first segment and externally threaded adjacent to the open terminus, such that the second segment is selectively threadedly attachable to the first segment and such that the tube is length adjustable by selective counterrotation of the second segment and the first segment.

3. The solid cleaning agent containment device of claim 1, wherein a length of the tube is adjustable between 10.0 to 25.0 cm.

4. The solid cleaning agent containment device of claim 3, wherein the length of the tube is adjustable between 12.7 to 20.3 cm.

5. A solid cleaning agent containment system comprising:
a tube comprising:
a first segment having a closed end and an open end, and
a second segment having a closed terminus and an open terminus, the second segment being circumferentially smaller than and adjustably positionable within the first segment, such that the tube is selectively length adjustable to fit substantially between a front wall and a rear wall of a tank of a toilet;
a solid cleaning agent positioned in the tube; and
a plurality of holes positioned in the tube, wherein the holes are configured for entry of water into the tube and for exiting of a solution resulting from dissolving of the solid cleaning agent in the water.

6. The solid cleaning agent containment system of claim 5, further including a toilet, the tube being positioned between a front wall and a back wall of a tank of the toilet.

7. The solid cleaning agent containment system of claim 5, wherein the solid cleaning agent comprises a chlorine tablet.

8. The solid cleaning agent containment system of claim 5, wherein:
the first segment of the tube is internally threaded adjacent to the open end; and
the second segment of the tube is circumferentially smaller than the first segment and externally threaded adjacent to the open terminus, such that the second segment is selectively threadedly attachable to the first segment and such that the tube is length adjustable by selective counterrotation of the second segment and the first segment.

9. The solid cleaning agent containment system of claim 5, wherein a length of the tube is adjustable between 10.0 to 25.0 cm.

10. The solid cleaning agent containment system of claim 9, wherein the length of the tube is adjustable between 12.7 to 20.3 cm.

11. A method of maintaining a clean and sanitary toilet comprising the steps of:
providing a toilet and a solid cleaning agent;
providing a solid cleaning agent containment device comprising:
a tube comprising:
a first segment having a closed end and an open end, and
a second segment having a closed terminus and an open terminus, the second segment being circumferentially smaller than and adjustably positionable within the first segment, such that the tube is selectively length adjustable to fit substantially between a front wall and a rear wall of a tank of a toilet, wherein the tube is configured for containing a solid cleaning agent and for positioning in a tank of a toilet, and
a plurality of holes positioned in the tube, wherein the holes are configured for entry of water into the tube and for exiting of a solution resulting from dissolving of the solid cleaning agent in the water;
adding the solid cleaning agent to the tube;
positioning the tube in a tank of a toilet between a front wall and a back wall of the tank;
allowing the solid cleaning agent to dissolve to form a solution; and
flushing the toilet when needed, such that the solution flows from the tank to a bowl of the toilet.

12. The method of claim 11, wherein the solid cleaning agent comprises at least one chlorine tablet.

13. The method of claim 12, wherein:
the first segment of the tube is internally threaded adjacent to the open end;
the second segment of the tube is circumferentially smaller than the first segment and externally threaded adjacent to the open terminus, such that the second segment is selectively threadedly attachable to the first segment and such that the tube is length adjustable by selective counterrotation of the second segment and the first segment; and
the step of the method for adding the solid cleaning agent to the tube entails:
threadedly decoupling the second segment from the first segment by selective counterrotation of the second segment and the first segment in a first direction,
adding the at least one chlorine tablet to one or both of the first segment and the second segment, and
threadedly coupling the second segment to the first segment by selective counterrotation of the second segment and the first segment in a second direction.

14. The method of claim 11, wherein a length of the tube is adjustable between 10.0 to 25.0 cm.

15. The method of claim 14, wherein the length of the tube is adjustable between 12.7 to 20.3 cm.
